(19) United States
(12) Patent Application Publication
(10) Pub. No.: US 2009/0240390 A1
(43) Pub. Date: Sep. 24, 2009

(54) SYSTEM AND METHOD FOR COMPONENT MONITORING

(76) Inventors: Nenad Nenadic, Penfield, NY (US); Michael G. Thurston, Penfield, NY (US); Michael Haselkorn, Fairport, NY (US); Gregory Von Pless, Cambridge, MA (US)

Correspondence Address: NIXON PEABODY LLP - PATENT GROUP, 1100 CLINTON SQUARE, ROCHESTER, NY, 14604, US

(21) Appl. No.: 12/053,191

(22) Filed: Mar. 21, 2008

(51) Int. Cl. G06F 19/00; G06F 7/00; G01M 17/00

(52) U.S. Cl. 701/31; 701/29; 701/30

(57) ABSTRACT

The health of components of an asset is proactively monitored. A sensor network provides a collection of metrics from a plurality of components of an asset. The collection of metrics includes a set of metrics corresponding to each component, and the set of metrics measures at least one operating characteristic, e.g. temperature, of the corresponding component. A component algorithm processing system receives the collection of metrics and determines a relationship between each set of metrics corresponding to each component and the collection of metrics corresponding to the plurality of components. The component algorithm processing system determines if the relationships indicate a health problem with at least one of the components. The metrics can be further analyzed to determine sensor faults, the remaining life, and the short-term and long-term health of each component. For example, the monitoring system can be applied to the plurality of planetaries on a light armored vehicle.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No.'s N00014-05-1-0708 and N00014-06-1-0998 awarded by the Office of Naval Research.

### FIELD OF THE INVENTION

This invention pertains generally to the monitoring of components of an asset and, more particularly, to a system and method for providing diagnostic and prognostic analysis of the health of the component based on measurements of one or more metrics corresponding to operational characteristics of the component.

### BACKGROUND

Complex assets, such as commercial and military vehicles, ships, aircraft, generator sets, industrial equipment, and other electromechanical systems, require regular maintenance to ensure that the systems continue to function properly. Often, critical components of these systems experience a higher degree of stress and/or wear, or are more susceptible to failure than other components. Accordingly, such critical components may be subject to more frequent maintenance and repair.

A light armored vehicle (LAV) is an example of a complex electromechanical system that includes critical components. LAV's typically are 8×8 wheeled, diesel-powered, lightly armored vehicles that can be employed in a wide range of military missions. For instance, in addition to providing other combat and combat support functions, LAV's can transport personnel, provide a weapons platform, function as a command-and-control vehicle, and perform logistical and recovery tasks. To further enhance their versatility, LAV's are designed and equipped to operate in a wide range of environments and terrains. For example, LAV's can travel on paved or unpaved roads, on hilly or level terrain, on wet or dry terrain, on- or off-road, etc. As such, the utility of LAV's depends significantly on their drive systems, which enable the LAV's to operate on most types of terrain. On the other hand, the all-terrain nature of LAV's places significant physical demands on the drive system.

Specifically, LAV's typically employ eight wheels including four wheels that are driven full time by the two rear axles and four wheels that can be optionally driven by the two front axles. All the wheels are coupled to the drive system, via wheel planetaries. In general, each planetary includes a central sun gear, a plurality of planet gears that orbit and mesh with the sun gear, and an outer ring with inner teeth that surround and mesh with the planet gears. The axle can drive the sun gear which then drives, via the planet gears, the outer ring and the wheel coupled to the outer ring. Proper functioning of the drive system, and of the LAV overall, depends on the health of these planetaries. Therefore, the planetaries are critical components that may be subject to more frequent maintenance and repair. Although LAV's can be repaired when failure of a planetary occurs, this reactive approach to maintenance requires unplanned downtime for the LAV. Such unplanned downtime can negatively impact execution of a military mission when the LAV is not available as expected or required by precise logistical planning. In addition, it may be difficult to prepare for, and respond effectively to, unexpected equipment failures, particularly when they occur in the field or battlefield. Even when scheduled maintenance is employed to take an LAV temporarily out of service and check the health of LAV components, including the planetaries, the frequency of these check-ups is limited by practical considerations. As a result, problems may not be identified in time to enable preventive action and to avoid major repairs and prolonged downtime.

### SUMMARY

To address the shortcomings of the approaches described previously, embodiments of the present invention provide an improved system and method that enables constant monitoring and proactive maintenance of components in an asset. Advantageously, the embodiments limit unplanned downtime and improve logistical planning by providing warnings as soon as problems with a component can be detected or predicted. With these warnings, corrective actions can be taken to prevent complete failure of the component and/or to prolong the service life of the electromechanical system. In some cases, because a warning can be provided well before failure, repairs and other corrective actions can be planned and logistical adjustments can be made in advance to minimize the impact of downtime. In other cases, the component has a finite operational life, but early warning enables arrangements to be made to retire and replace the asset.

Accordingly, in one embodiment, a sensor network provides a collection of metrics from a plurality of components of an asset. The collection of metrics includes a set of metrics corresponding to each component, and the set of metrics measures at least one operating characteristic of the corresponding component. A component algorithm processing system receives the collection of metrics and determines a relationship between each set of metrics corresponding to each component and the collection of metrics corresponding to the plurality of components. The component algorithm processing system then determines if the relationships indicate a health problem with at least one of the components.

For example, particular embodiments may provide diagnostic and prognostic analysis of the health of the LAV planetaries described previously. A LAV has a plurality of planetaries, e.g., eight planetaries, each of which can be mounted with a sensor that continuously samples the temperature of the planetary. The temperature of a planetary provides an indicator of the health of the planetary. Temperature measurements from the plurality of pluralities provide a running statistical basis for quickly identifying outlier temperature measurements that indicate that a problem exists with the corresponding planetary. The temperature measurements can be further analyzed to determine sensor faults as well as the remaining life and the short-term and long-term health of each planetary. Because the temperature measurements are collected from a plurality of similar planetaries subject to similar, or substantially similar, operating conditions, the analysis of each planetary relative to the plurality of planetaries does not have to account for the operating conditions and is thus independent of operating context.

Aspects of the present invention, for instance, may be employed as a part of a system, known as an Asset Health Management (AHM) system. The AHM provides a framework for building health monitoring systems. The AHM can read data from a sensor network, run multiple levels of data processing algorithms to identify any system anomalies, and make diagnostic and prognostic assessments. The AHM system can be applied to military and non-military platforms, such as ships, aircraft, and ground vehicles, to enhance command and control effectiveness, improve maintenance and supply logistics, and reduce operations and support costs.

These and other aspects of the present invention will become more apparent from the following detailed description of the preferred embodiments of the present invention when viewed in conjunction with the accompanying drawings.

### BRIEF DESCRIPTION OF THE DRAWINGS

FIG. 1 illustrates a dataflow for providing diagnostic and prognostic analysis of the health of a component according to aspects of the present invention.

FIG. 2A illustrates a planetary of a light-armored vehicle (LAV) that may be subject to diagnostic and prognostic analysis according to aspects of the present invention.

FIG. 2B illustrates a housing in which the planetary of FIG. 2A is disposed.

FIG. 2C illustrates a graph demonstrating how temperatures at the pins of the planetary of FIG. 2A are estimated from temperatures measured at the front plate of the housing of FIG. 2B, according to aspects of the present invention.

FIG. 3A illustrates a graph of data that is sampled at a non-uniform rate according to aspects of the present invention.

FIG. 3B illustrates a graph of the data of FIG. 3A along with zero-order interpolated samples calculated according to aspects of the present invention.

FIG. 4 illustrates a graph of a typical distribution of the correlation coefficient calculated between two healthy planetaries according to aspects of the present invention.

FIG. 5A illustrates a graph of the detection time against the correlation coefficient threshold calculated according to aspects of the present invention.

FIG. 5B illustrates a graph of false alarm rate against the correlation coefficient threshold calculated according to aspects of the present invention.

FIG. 5C illustrates a time domain plot of temperatures for eight planetaries R1-R4 and L1-L4, where one of the temperature sensors fails.

FIG. 6A illustrates a time domain plot of temperatures for the eight planetaries collected according to aspects of the present invention, along with the mean temperature.

FIG. 6B illustrates a distribution of differences between the mean temperature and the temperatures for the eight planetaries collected according to aspects of the present invention.

FIG. 7 illustrates a time domain plot of temperatures of eight planetaries where one of the planetaries has a low oil level.

FIG. 8A illustrates a method for determining an outlier from temperature measurements according to aspects of the present invention.

FIG. 8B illustrates a distribution of outlier characteristics r computed according to aspects of the present invention during a series of missions in the field where the planetaries remained healthy.

FIG. 9 illustrates a graph of the relationship between wear coefficient and temperature, as employed by aspects of the present invention.

FIG. 10 illustrates a single-node neural network that receives previous temperature and speed values as inputs and outputs the next planetary temperature value using gradient descent learning with a momentum term according to aspects of the present invention.

FIG. 11A illustrates a graph of distributions for a three-minute horizon determined according to the neural network of FIG. 10.

FIG. 11B illustrates a graph of distributions for a five-minute horizon determined according to the neural network of FIG. 10.

FIG. 11C illustrates a graph of distributions for an eight-minute horizon determined according to the neural network of FIG. 10.

FIG. 11D illustrates a graph of distributions parameters as a continuous function of horizon corresponding to the neural network of FIG. 10.

FIG. 12A illustrates a graph of the relationship between the actual steady state temperature and the predicted steady state temperature as calculated according to aspects of the present invention.

FIG. 12B illustrates a graph of the mean error between the actual steady state temperature and the uncorrected predicted steady state temperature as calculated according to aspects of the present invention. It also illustrates a graph of the mean error between the actual steady state temperature and the corrected predicted steady state temperature as calculated according to aspects of the present invention.

FIG. 13A illustrates an example membership function for outlier r-values employed according to aspects of the present invention.

FIG. 13B illustrates an example membership function for raw temperature values employed according to aspects of the present invention.

FIG. 13C illustrates an example membership function for predicted temperature values employed according to aspects of the present invention.

FIG. 14 illustrates a diagram of an Asset Health Management system according to aspects of the present invention.

### DETAILED DESCRIPTION

Embodiments of the present invention provide an improved system and method that enables constant monitoring and proactive maintenance of components in an asset, such as a complex electromechanical device or vehicle. The embodiments collect data regarding one or more of the component's operational characteristics and analyze this data to determine the current and projected health of the component.

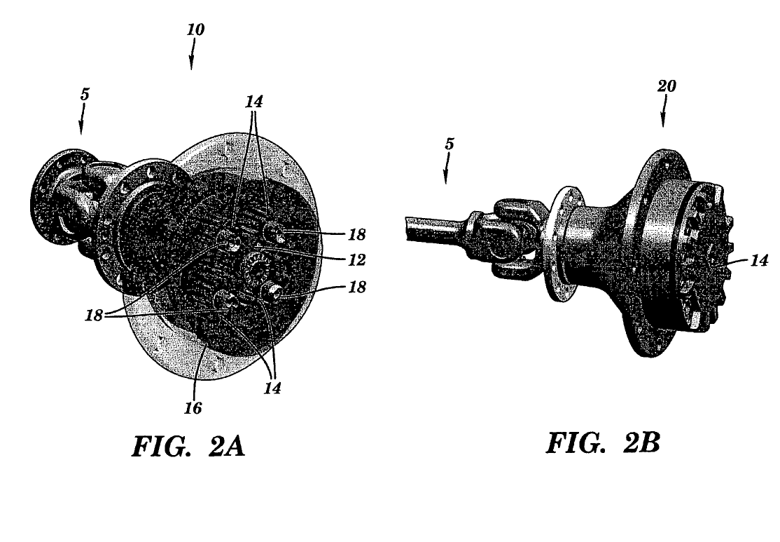

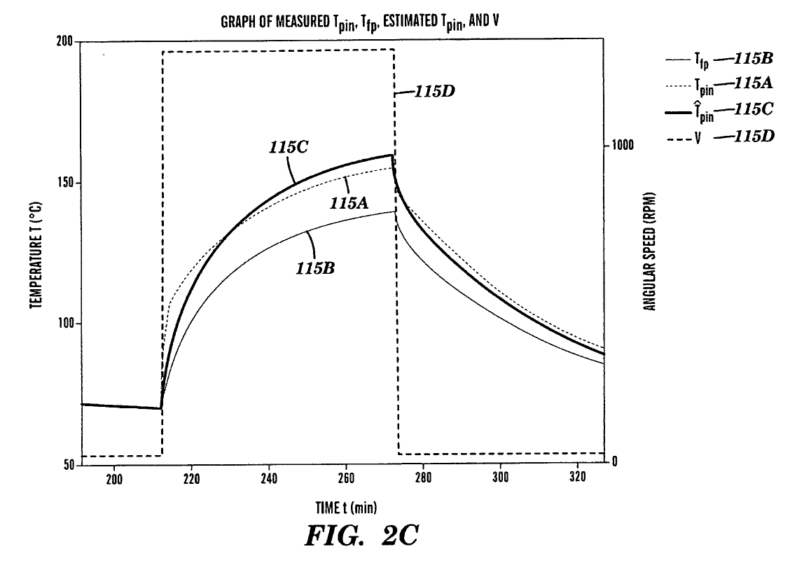

To illustrate aspects of the present invention, a planetary diagnostic-prognostic system (PDPS) for analyzing the health of planetaries of light armored vehicles (LAV's) is described. A LAV typically employs eight wheels that are coupled to the rest of the drive system via wheel planetaries. As shown in FIG. 2A, a planetary 10 includes a central sun gear 12, a plurality of planet gears 14 that orbit and mesh with the sun gear 12, and an outer ring 16 with inner teeth that surround and mesh with the planet gears 14. The axle 5 can drive the sun gear 12 which then drives, via the planet gears 14, the outer ring 16 and the wheel (not shown) coupled to the outer ring 16. As described previously, the planetaries are critical components in a LAV, and proper functioning of the drive system, and of the LAV overall, depends on the health of such planetaries. The temperature of a planetary provides an indicator of the health of the planetary. Therefore, embodiments of the PDPS may employ sensors to measure the temperature of each planetary. However, it is contemplated that appropriate metrics corresponding to other operating characteristics of the planetary may be measured to determine planetary health.

Temperature measurements from the plurality of planetaries provide a running statistical basis for quickly identifying sensor faults and outlier temperature measurements that indicate a problem with the corresponding planetary. The outlier data may indicate that the health of one of the planetaries is deteriorating or is experiencing another problem, such as an oil leak. In the example embodiment, the PDPS employs an outlier-detection algorithm with the data from all planetaries to can detect small deviations (anomalies) in the temperature data corresponding to one of the planetaries.

In general, the planetaries are all similar and are subject to substantially similar operating conditions, i.e., operating context. In this case, when an outlier is identified from the temperature measurements of all of the planetaries, the operating conditions can generally be ruled out as a cause for this outlier. As a result, the PDPS is advantageously employing an approach that is independent of operating context.

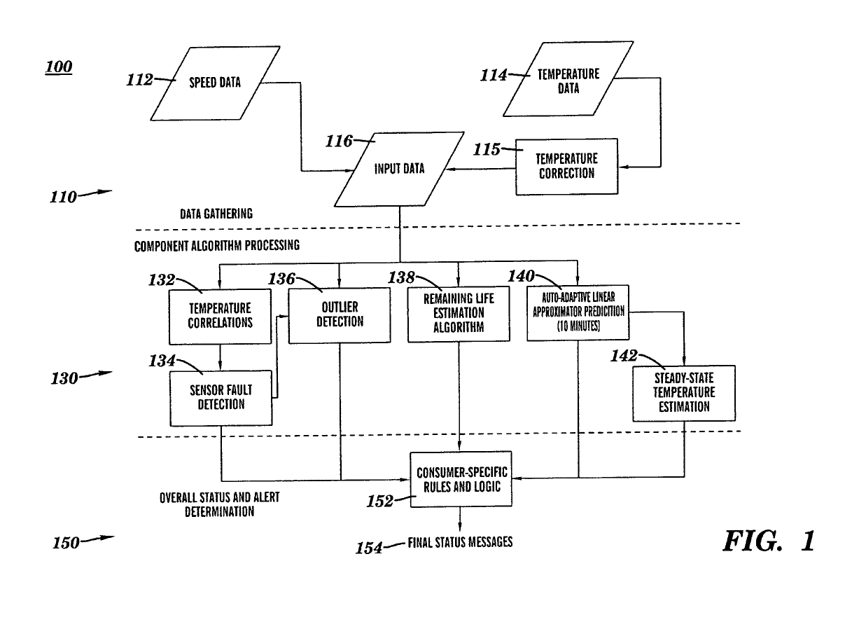

Referring now to FIG. 1, a dataflow 100 employed by a PDPS is illustrated. As shown by FIG. 1, the dataflow 100 can be logically divided into data gathering steps 110, component algorithm processing steps 130, and overall status and alert determination steps 150. In general, the data gathering steps 110 provide the input to the processing algorithms of steps 130 and the results are provided as output in status and alert determination steps 150.

In the data gathering steps 110, speed data 112 is collected for the LAV, and temperature data 114 is collected for the planetaries on the LAV. The temperature data 114 is measured at locations where it is feasible to mount temperature sensors. However, it may not be feasible to collect temperature data 114 directly from desired locations, i.e., the actual points of interest, on the planetaries. For example, FIG. 2A illustrates pins 18 that couple the planet gears 14 to the planetary 10. The pins 12 are the desired measuring points for monitoring planetary temperature. Although the pins 12 in a laboratory setting may be accessible and temperature sensors can be mounted on pins 12 in this controlled setting, it may not be feasible to mount temperature sensors on the pins 12 for a planetary that is used in other settings, e.g., in the field. Indeed, as FIG. 2B illustrates, for a planetary used in the field, it is more feasible to mount a temperature sensor on a front plate 22 of the housing 20 in which the planetary 10 is disposed. As a result, it is necessary to correlate the temperature actually measured on the front plate 22 of the housing 20 to the temperatures at the pins 12, which are of greater interest. As shown further in FIG. 1, the measured temperature data 114 is corrected, or adjusted, in step 115 to provide estimates of the temperatures at the points of interest, i.e., the pins 12. The temperature correction of step 115 may be realized as a linear estimator, where the parameters are obtained from experimentally-measured data. In the experimental setting, temperatures at the pins 12 can be measured and compared to the temperature measured at the front plate 22. Coefficients are derived from the comparison between the temperatures at the pins 12 and the front plate 22. Furthermore, the coefficients are optimized to minimize the error between the measured temperature of the pins 12 and the estimated temperature of the pins 12. To provide an example, FIG. 2C illustrates measurements that were collected from a planetary under controlled conditions on a dynamometer. In particular, FIG. 2C shows the measured pin temperature (Tₚᵢₙ) 115A, measured front-plate temperature (T_{fp}) 15B, estimated pin temperature Tₚᵢₙ 115C, and the context variable speed (V) 115D.

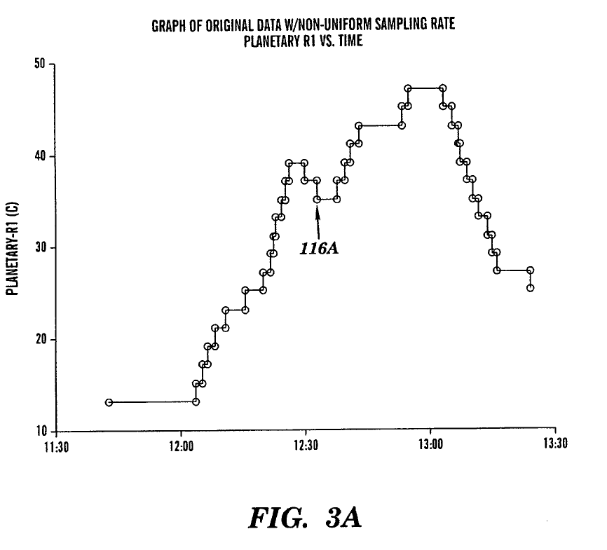

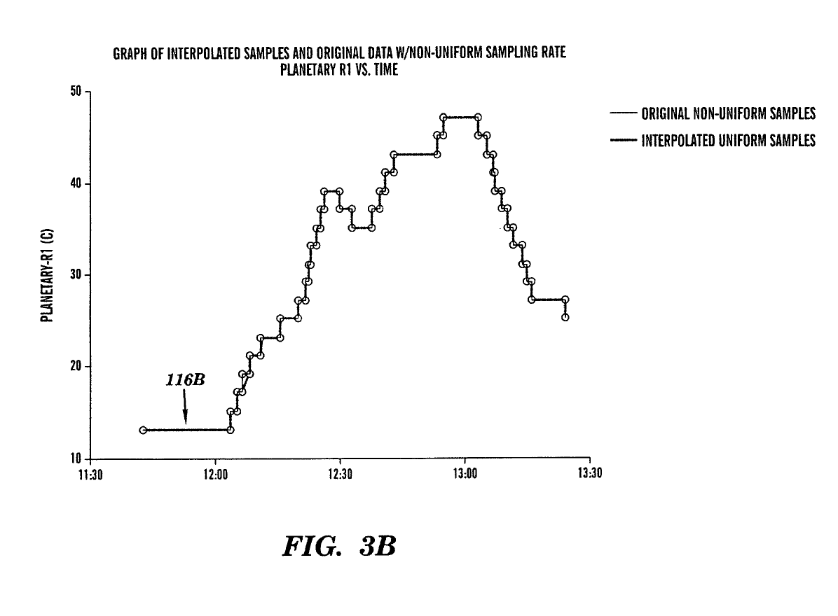

Referring again to FIG. 1, the speed data 112 and the corrected temperature data 114 are processed to produce an input data block 116 for the component algorithm processing steps 130. The sampled speed data 112 and/or the temperature data 114 are converted into a form required by component data processing algorithms. For example, during the data gathering steps 110 in some embodiments, a new data point is stored only if it differs from the previously stored data point by a prescribed amount. Although this approach may save a large amount of memory, it produces a non-uniform sampling rate, which may be incompatible with the algorithms for the component data processing steps 130. Therefore, the data gathering steps 110 can restore the uniformity of the sampling using zero-order interpolation. FIG. 3A illustrates an example of data 116A sampled at a non-uniform rate during the data gathering steps 110. FIG. 3B illustrates the original collected data of FIG. 3A along with the zero-order interpolated samples 116B.

As further shown in FIG. 1, the component algorithm processing steps 130 processes the input data block 116, including the speed data 112 and the corrected temperature data 114. In particular, the processing 130 provides diagnostic analysis of the planetaries by detecting sensor faults in step 134 and identifying data outliers in step 136. Furthermore, the processing 130 provides prognostic analysis of the planetaries by determining the remaining life of the planetaries in step 138, determining short-term health of the planetaries in step 140, and determining the long-term health of the planetaries in step 142.

To detect sensor faults in step 134, the PDPS first calculates temperature correlations in step 132. In particular, step 132 computes statistical cross-correlations ρ_{xy} for collected temperature data between each of the planetaries, e.g., eight planetaries. The computation of cross-correlations ρ_{xy} includes computing means μ_{N} and standard deviations σ_{N} of temperature measurements x and y over N samples for two respective planetaries. Standard iterative algorithms, for example, may be employed to compute μ_{N}, σ_{N}² and ρ_{xy}:

$$\begin{matrix}{μ}_{N} = \frac{1}{N} [ ( N - 1 ) {μ}_{N - 1} + {x}_{N} ] , & ( 1 ) \\ {σ}_{N}^{2} = \frac{1}{N - 1} [ ( N - 2 ) {σ}_{N - 1}^{2} + {( {x}_{N} - {μ}_{N} )}^{2} ] . & ( 2 ) \\ {σ}_{XY , N}^{2} = \frac{1}{N - 1} [ ( N - 2 ) {σ}_{XY , N - 1}^{2} + ( {x}_{N} - {μ}_{X , N} ) ( {y}_{N} - {μ}_{Y , N} ) ] & ( 3 ) \\ {ρ}_{XY , N} = \sqrt{\frac{{σ}_{X , N}^{2} {σ}_{Y , N}^{2}}{{σ}_{XY , N}^{2}}} & ( 4 )\end{matrix}$$

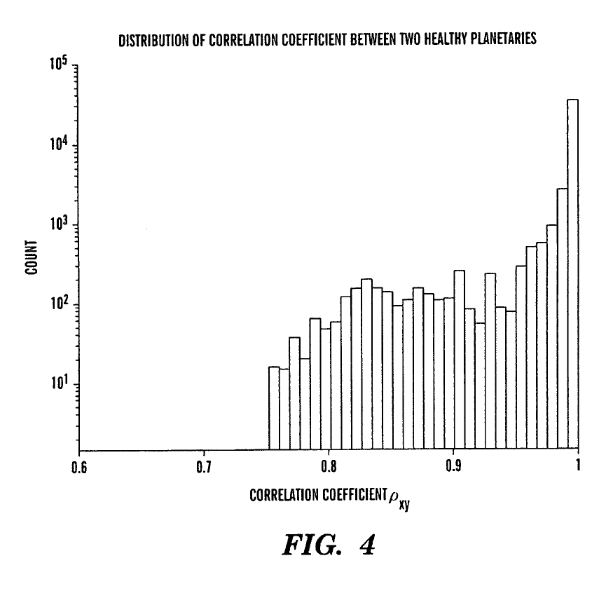

As the cross-correlations ρ_{xy} measure the relationship between the temperature data collected by two sensors subject to substantially similar operating contexts, a low cross-correlation may indicate a fault with a sensor. As such, step 134 detects sensor faults by applying thresholds on the cross-correlations computed in step 132. FIG. 4 illustrates an example of a typical distribution of the correlation coefficient between two healthy planetaries when temperature data is accumulated for 5 minutes. As seen in example of FIG. 4, the correlation is typically higher than 0.75. As a result, 0.75 appears to be a reasonable threshold for detecting faulty sensors. In this case, choosing 0.75 for the threshold can be confirmed by collecting temperature data when there is an actual fault with one of the planetary temperature sensors.

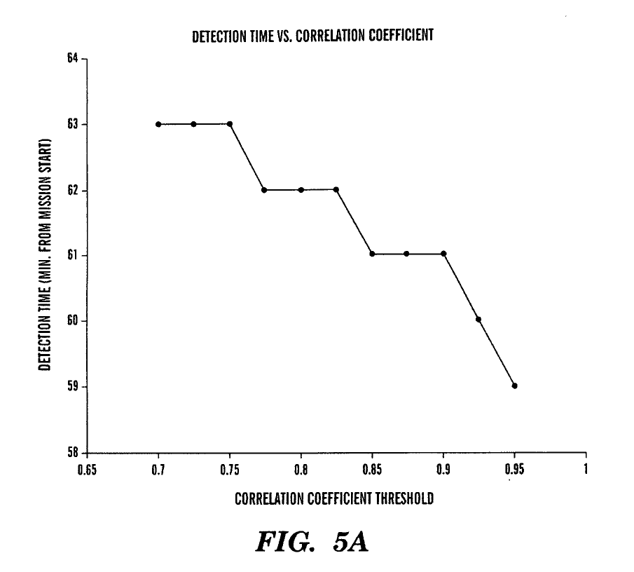

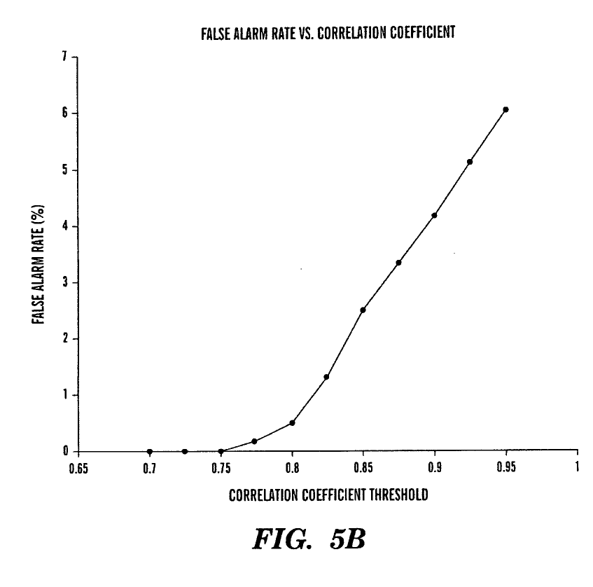

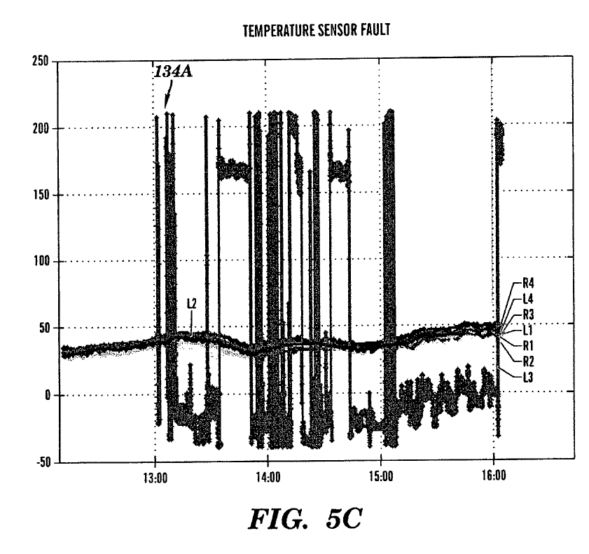

Ideally, the time to detect a failure of a planetary temperature sensor is as short as possible, while the number of false alarms regarding the failure of a planetary temperature sensor is as low as possible. A low rate of false alarms indicates a high accuracy in the failure detection. However, FIGS. 5A-5C demonstrate that there is a trade-off between achieving a short detection time and lowering the false alarm rate for different correlation thresholds. In particular, FIG. 5A shows a graph of the detection time against the correlation coefficient threshold. The time (from the start of the mission for example) to detect the failure of the planetary temperature sensor generally decreases as the threshold increases. Meanwhile, FIG. 5B shows a graph of false alarm rate against the correlation coefficient threshold. The false alarm rate in FIG. 5B generally increases as the correlation increases beyond 0.75. In addition, FIG. 5C shows a time domain plot of temperatures for eight planetaries R1-R4 and L1-L4, where one of the temperature sensors fails. Specifically, the curve 134A corresponding to sensor L3 indicates a failure of the sensor L3 at approximately 13:00 as the curve departs from the curves corresponding to the other sensors R1-R4, L1-L2, and L4. The sensors R1-R4, L1-L2, and L4 indicate planetary temperatures having similar temperatures and curve shapes between approximately 30° C. and 50° C. over time, and the agreement, i.e. correlation, between these other sensors suggests that the sensors are functioning properly.

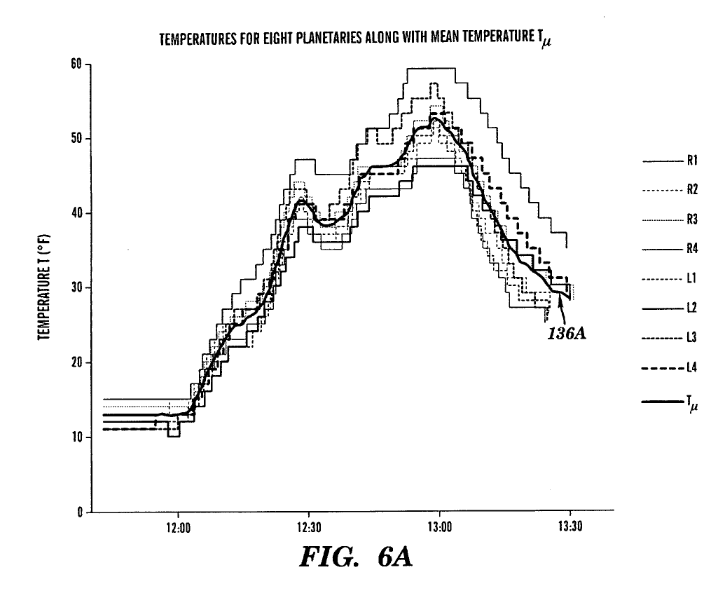

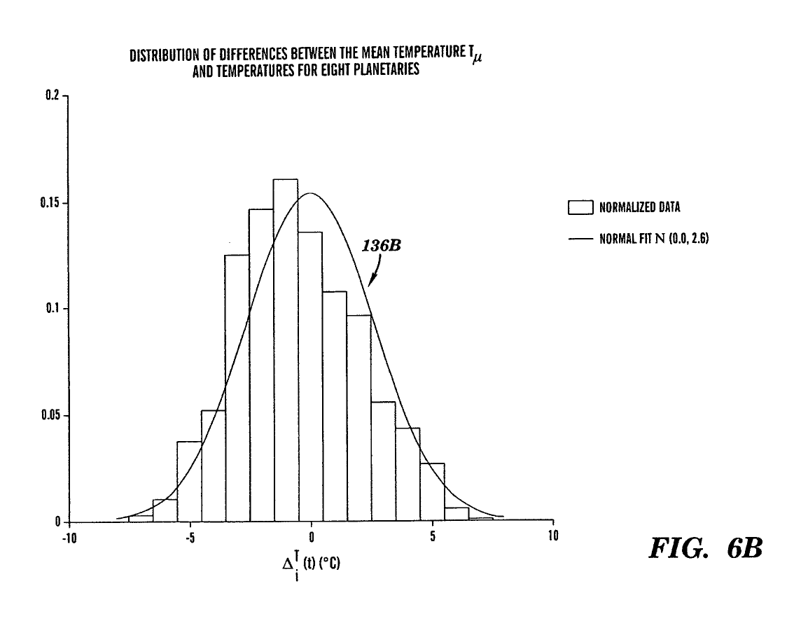

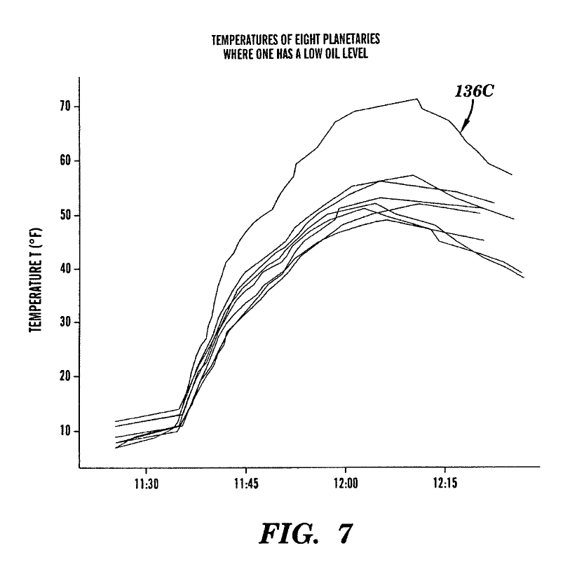

Assuming that there are no sensor faults on any of the planetaries, step 136 as shown in FIG. 1 further analyzes the temperature measurements to detect outlier data for the eight planetaries. FIG. 6A illustrates a time domain plot of the temperatures for the eight planetaries. FIG. 6A also indicates the mean temperature T_{μ}. Meanwhile, FIG. 6B illustrates a distribution of differences between the temperatures for the eight planetaries and the mean temperature T_{μ}136A. The distribution shows that the distribution of differences corresponds favorably with a normal fit 136B. FIG. 7 illustrates a time domain plot of temperatures of eight planetaries where one of the planetaries has a low oil level. In particular, the curve 136C, which corresponds to the planetary with the low oil level, shows that the temperatures for the planetary are higher than the other planetaries which generally have similar temperatures. As such, temperature measurements may be employed to identify potential outliers caused, for example, by low oil levels or other problems. As temperature measurements can be sampled continuously, processing of the temperature measurements in real-time or near real-time enables a problem with the planetary to be detected more quickly than periodic monitoring or scheduled inspections.

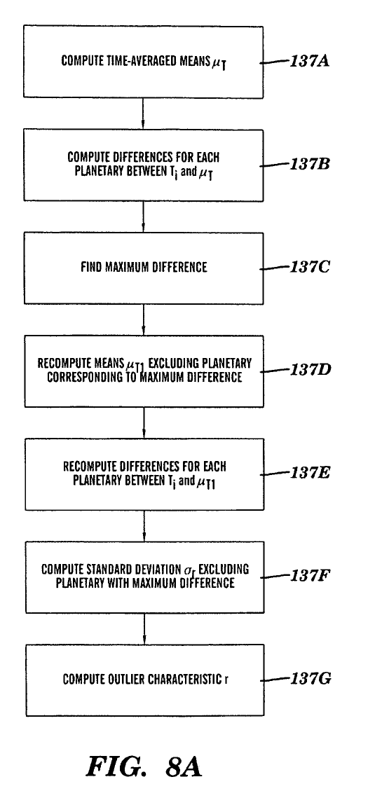

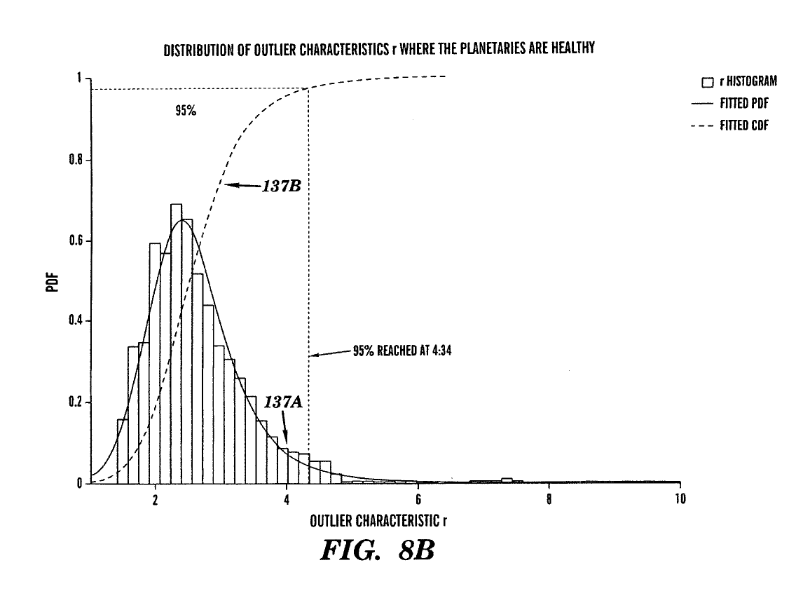

An example process for computing outlier characteristics r in step 136 is outlined as substeps 137A-G in FIG. 8A. In substep 137A, the mean μ_{T} of the temperatures Tᵢ of the eight planetaries is computed as a function of time t. The time-averaged mean μ_{T} corresponding to each given sample time t is computed as:

$${μ}_{T} ( t ) = \frac{1}{8} {\sum }_{i = 1}^{8} {T}_{i} . \qquad ( 5 )$$

For each of the eight planetaries i, substep 137B computes the difference Δᵢ^{T}, over a sampling period, tₛₜₐᵣₜ to t_{end}, between each sampled temperature Tᵢ and the mean temperature μ_{T} for the corresponding sample time t:

$${Δ}_{i}^{T} = {\int }_{tstart}^{tend} [ {T}_{i} ( t ) - {μ}_{T} ( t ) ] d t . \qquad ( 6 )$$

From the differences Δᵢ^{T} computed in substep 136B, the maximum difference is identified in substep 137C. The maximum difference corresponds to a planetary k of the eight planetaries i and is a potential outlier:

$$k = {arg max}_{i} ( {Δ}_{i}^{T} ) . \qquad ( 7 )$$

Substep 137D recomputes the mean μ_{T1} at each given sample time t for all of the planetaries i except for the planetary k corresponding to the potential outlier identified in substep 137C:

$${μ}_{T 1} ( t ) = \frac{1}{7} {\sum }_{{i = 1}_{i \neq k}}^{8} {T}_{i} . \qquad ( 8 )$$

For each of the eight planetaries i, substep 137E computes the difference Δᵢ^{T1} over the entire sampling period between each sampled temperature Tᵢ and the mean temperature μ_{T1} calculated in step 137D at the corresponding sample time t:

$${Δ}_{i}^{T 1} = {\int }_{tstart}^{tend} [ {T}_{i} ( t ) - {μ}_{T 1} ( t ) ] d t . \qquad ( 9 )$$

Excluding the largest difference corresponding to i=k, substep 137F computes the standard deviation σᵣ for the differences Δᵢ^{T1} calculated in step 137E:

$${σ}_{r} = \sqrt{\frac{1}{6} {\sum }_{{i = 1}_{i \neq k}}^{8}} {( {Δ}_{i}^{T 1} )}^{2} . \qquad ( 10 )$$

Determining the ratio between the largest difference Δᵢ^{T1} corresponding to i=k and the standard deviation σᵣ computed in substep 137F, substep 137G computes the outlier characteristic r:

$$r = \frac{{Δ}_{k}^{T 1}}{{σ}_{r}} \qquad ( 11 )$$

The outlier characteristic r provides an indicator of the health of the planetary corresponding to i=k. The value of the outlier characteristic r may indicate that the corresponding planetary is deteriorating or experiencing another problem, such as an oil leak. A subsequent, e.g., second, outlier can be found by excluding the planetary corresponding to the first outlier and executing substeps 137A-G modified for fewer planetaries, e.g., seven planetaries. FIG. 8B illustrates a distribution of outlier characteristics r computed during a series of missions in the field where the planetaries remained healthy and experienced no problems. FIG. 8B also illustrates a fitted probability density function (PDF) 137A and a fitted cumulative density function (CDF) 137B.

Although the substeps 137A-F are described herein as an effective approach for identifying an outlier, it is contemplated that other statistical approaches may be employed. In general, to determine whether the planetary is functioning differently from the other planetaries and perhaps malfunctioning, embodiments evaluate the relationship between the temperature measurements corresponding to the single planetary and the measurements corresponding to the other planetaries.

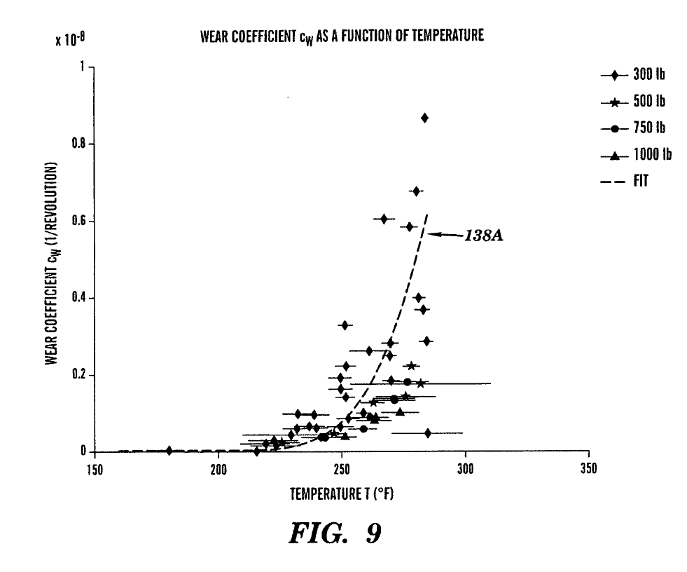

As shown in FIG. 1, the PDPS, in step 138, also employs an algorithm to determine the remaining useful life of the planetaries. This calculation can be made according to the remaining bushing thickness of the planetary. FIG. 9 illustrates the empirically-determined wear coefficient c_{w} as a function of temperature. In particular, FIG. 9 shows the experimentally-determined relationship 138A between wear coefficient c_{w} and the bushing temperature, where measurements were taken on a bushing tester. The wear coefficient c_{w} can be converted to wear ratio r_{w} as follows:

$${r}_{w} [ \frac{in}{min} ] = {c}_{w} \times ( circumference [ in ] ) ( ω [ RPM ] ) \times ( bushing - dyno ratio ) . \qquad ( 12 )$$

Every time a new sample n for planetary temperature Tₛ is collected, the fit of FIG. 9 is used to compute the wear ratio r_{w}. The remaining bushing thickness t_{b} is then determined as follows:

t_{b}[nTₛ]=t_{b}[(n−1)Tₛ]−r_{w}[n]Tₛ. (13)

When the bushing thickness t_{b} reaches a minimum value, the planetary has reached the end of its operational life. As such, calculating bushing thickness t_{b} indicates the planetary's remaining life and how much use may be further expected from the planetary. Because the thickness of the planetary is not measured either directly or indirectly, the error of the estimated remaining thickness grows exponentially with time. The sources of error may include error in the temperature measurement, error in the estimation of the bushing temperature, error of the fit approximation, including variance of the fit, and the approximation errors corresponding to the determination of the wear ratio r, or the remaining bushing thickness t_{b}. Nevertheless, step 138 provides a useful estimate for the planetary's remaining life.

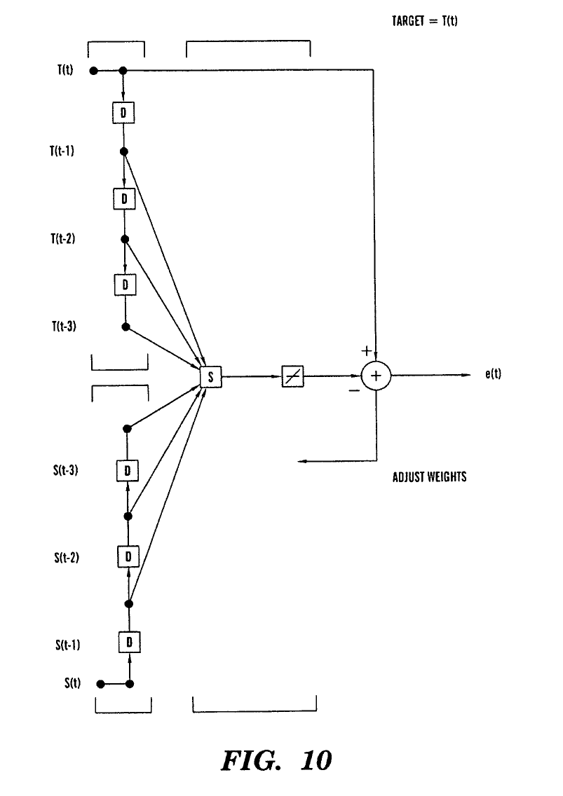

Referring again to FIG. 1, the PDPS, in step 140, also employs an auto-adaptive linear approximator, which is a single-node neural network that receives previous speed data 112 and temperature data 114 as inputs and outputs the next planetary temperature value. FIG. 10 illustrates a single-node neural network which employs gradient descent learning with a momentum term to perform its adaptation. As shown in FIG. 10, three previous known values T(t-1), T(t-2), and T(t-3) are weighted and summed to produce the temperature prediction. The latest known temperature T(t) value is used in the learning phase for weight adjustment.

Mathematically, the forward phase is the dot product of the input vector and the weight vector. Specifically, the input vector P is defined as follows:

$${P ( t )}_{2 d \times 1} = [ \begin{matrix}T ( t - 1 ) \\ T ( t - 2 ) \\ ⋮ \\ T ( t - d ) \\ S ( t - 1 ) \\ S ( t - 2 ) \\ ⋮ \\ S ( t - d )\end{matrix} ] , \qquad ( 14 )$$

where T represents the planetary temperature, S represents the speed, t represents the current time, and d represents the number of delayed sensor values the network accepts as input. The network's temperature prediction for time t is expressed as:

$${T}_{p} ( t ) = {W ( t )}_{1 \times 2 d} {P ( t )}_{2 d \times 1} . \qquad ( 15 )$$

The neural network employs “gradient descent” learning with a momentum term to perform its adaptation. Training must be conducted at every time step. However, a minimum square error (MSE) threshold may be set such that if the network prediction's MSE is lower than the threshold, training may be skipped for the current time step. At each time step, the raw prediction error is the difference between the prediction and actual value:

δ(t)=T(t)−Tₚ(t). (16)

The weight change vector, which is added to the current weight vector to get the updated weights, is calculated as follows:

$$Δ {W ( t )}_{1 \times 2 d} = βΔ {W ( t - 1 )}_{1 \times 2 d} + αδ ( t ) {P ( t )}_{2 d \times 1} , \qquad ( 17 )$$

where β is the momentum term and α is the learning rate.

When performing a 5-minute future prediction, for example, beginning at time tₚ, the following input vector P is used:

$${P ( t )}_{2 d \times 1} = [ \begin{matrix}{T}_{p} ( t ) \\ {T}_{p} ( t - 1 ) \\ ⋮ \\ {T}_{p} ( t - ( d - 1 ) ) \\ S ( {t}_{p} ) \\ S ( {t}_{p} ) \\ ⋮ \\ S ( {t}_{p} )\end{matrix} ] \qquad ( 18 )$$

In effect, the network becomes recurrent, feeding itself input rather than taking input from sensors. Since there is no speed prediction, speed is held constant. Another option is to utilize speed values occurring between successive temperature values, as speed tends to update more quickly.

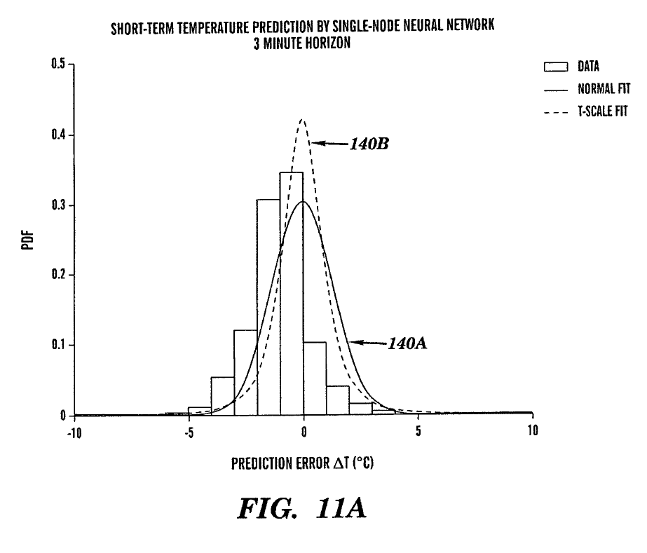

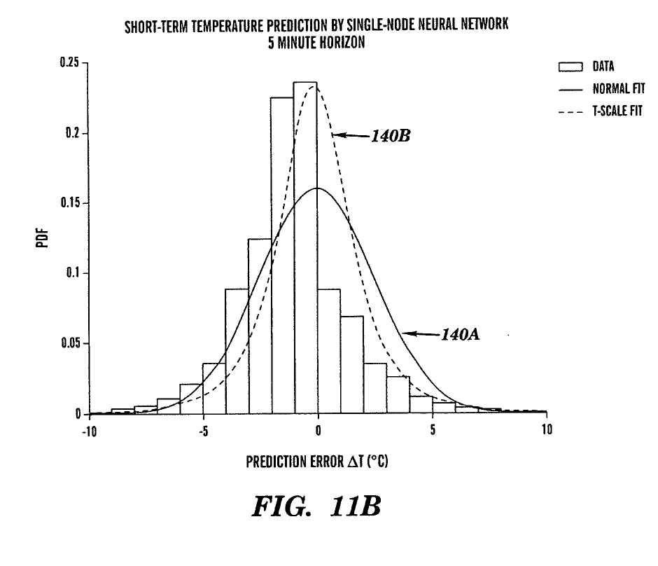

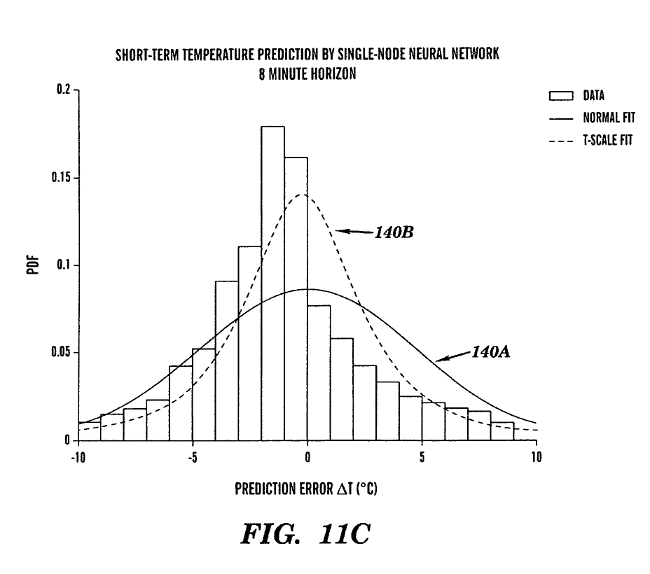

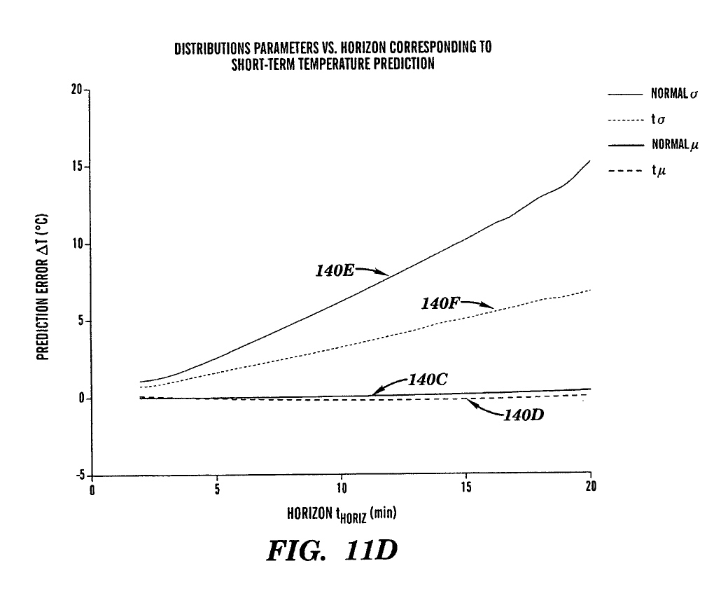

To demonstrate the success of short-term prediction according to the approach above and to attribute confidence levels to predictions made for different lengths (horizons), experiments were conducted to make predictions were made for eight planetary gears over six missions in the field and for horizons in the range of 2 to 20 minutes. Each experiment included 4 trials, so that the data sets used to extract probability density functions each consisted of approximately 54,000 points. A normal PDF (normal) and at Location-Scale PDF (t-scale) were fitted to the error data for each horizon. FIGS. 11A-C illustrate examples of a normal fit 140A and a t-scale fit 140B for error data corresponding to horizon values of three minutes, five minutes, and eight minutes, respectively. In addition, FIG. 11D illustrates the distribution parameters as a continuous function of horizon, including the normal distribution mean (normal μ) 140C, the t-scale distribution mean (t μ) 140D, the standard deviation for the normal distribution (normal σ) 140E, and the standard deviation for the t-scale distribution (t σ) 140F. As FIG. 11D shows, the standard deviations 140C and 140D for both the normal distribution and the t-scale distribution, respectively, become larger as the horizon time increases; however, the standard deviation is larger for the normal distribution. Accordingly, the t-scale distribution provides a much better fit. The normal distribution, meanwhile, offers a conservative spread, which provides a sort of safety cushion when determining confidence levels. As a result, both the normal PDF and the t-scale distribution can be useful.

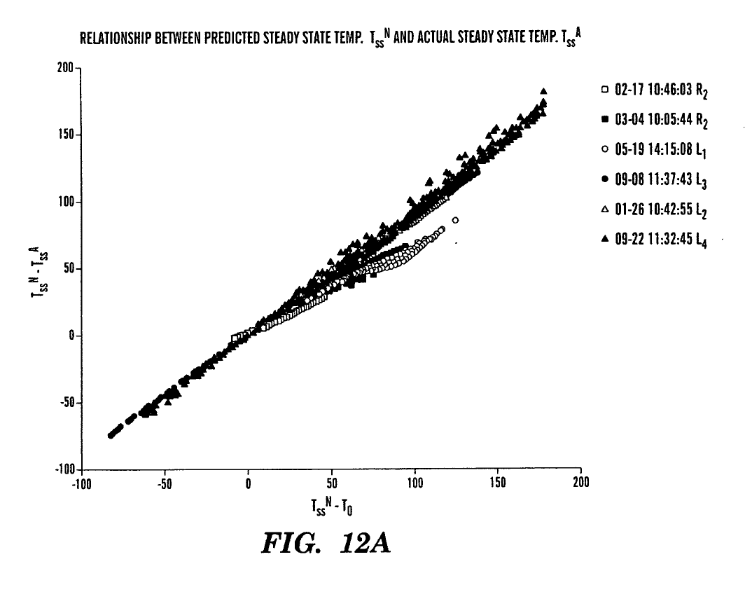

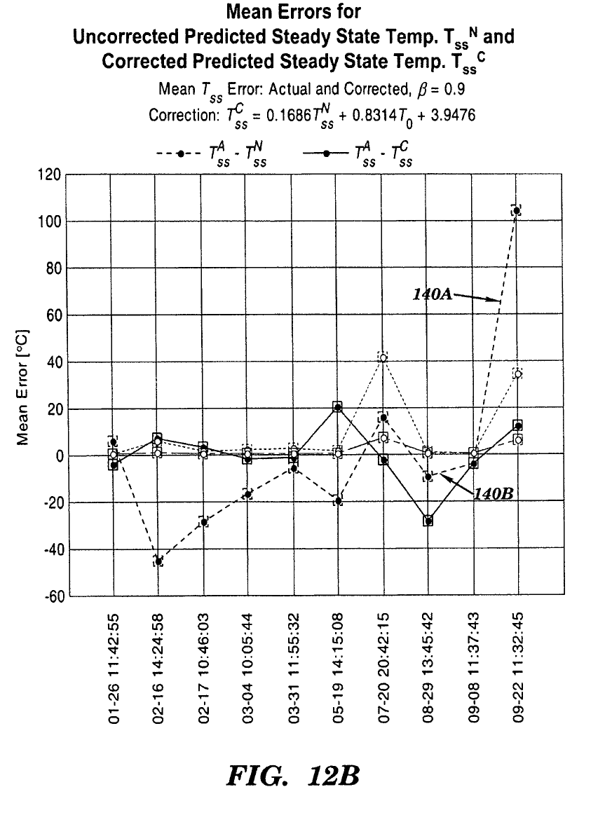

As FIG. 1 further illustrates, the PDPS, in step 142, also provides steady state temperature estimation, i.e., long term temperature prediction, by employing an approach similar to calculating short term predictions in step 140 described previously. However, as FIGS. 12A and 12B illustrate, an additional correction is employed for long term temperature predictions. In particular, FIG. 12A shows the relationship between the predicted steady state temperature T_{SS}^{N} and the actual steady state temperature T T_{SS}^{A}. From the relationship shown in FIG. 12A, an expression can be determined to calculate a corrected predicted steady state temperature T_{SS}^{C}. For example, the corrected steady state temperature is calculated as: T_{SS}^{C}=0.1686 T_{SS}^{N}+0.8314T₀+3.9476. FIG. 12B illustrates the mean error 142A between the actual steady state temperature T_{SS}^{A} and the uncorrected predicted steady state temperature T_{SS}^{A} as well as the mean error 142B between the actual steady state temperature T_{SS}^{A} and the corrected predicted steady state temperature T_{SS}^{C}. In general, the corrected predicted steady state temperature T_{SS}^{C} provides a more accurate long term temperature prediction.

Estimating future temperature from its past values and incomplete knowledge of the context in the manner taught herein can be applied to other heat generation processes. Indeed, the unique feature of the neural network employed by the present invention, for example, is its structural simplicity and a specially-tailored learning method.

In sum, the component algorithm processing steps 130 shown in FIG. 1 receive speed data 112 and corrected temperature data 114 to evaluate the current health of the planetaries of a LAV. Step 132 calculates cross-correlations between pairs of planetaries and identifies sensor faults when a cross-correlation exceeds a threadhold, such as 0.75. Step 134 then computes an outlier characteristic for a possible outlier, which is identified by comparing the temperature measurements for a planetary against a mean temperature calculated for all planetaries. Step 136 calculates the remaining useful life of each planetary by determining a bushing thickness according to an empirical relationship between wear coefficient and bushing temperature. Steps 138 and 140 then make predications of short-term and long-term temperatures, respectively, for each planetary according to a single-node neural network.

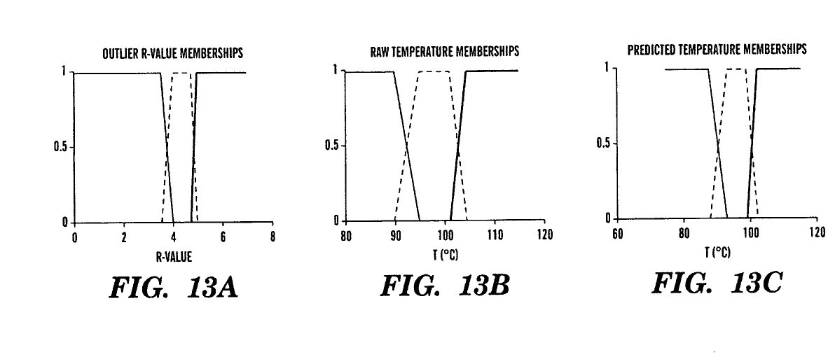

As further shown in FIG. 1, the steps 150 for overall status and alert determination include applying consumer specific rules and logic in step 152. For example, step 152 applies thresholds to the corrected temperatures, short-term temperature predictions, long-term temperature predictions, and outlier r-values in a fuzzy manner to determine membership values in fuzzy sets, e.g., LOW, MED, and HI, for each variable. In other words, the results calculated in the component algorithm processing steps 130 are categorized according to selected thresholds. FIG. 13 illustrates some example membership functions. FIG. 13A shows the memberships for outlier r-values. FIG. 13B shows memberships for raw temperature values. FIG. 13C illustrates memberships for predicted temperature memberships. These memberships are used by the consumer-specific rules and logic to determine the final status in step 154.

Finally, step 154 converts the outputs of the logic to messages are easy to understand when communicated via a user interface to operators, or other individuals, so that the appropriate response to planetary health can be made. For example, driver outputs may be color-coded as follows:
Black—sensor broken or unreliable, cannot assess planetary
Green—planetary is working properly
Orange—planetary is heating abnormally
Red—planetary temperature is approaching critical temperature; change driving conditions if possible.
   However, it is contemplated that other sensory indicators, e.g., visual, aural, tactile, etc., may be employed to communicate the health of the planetaries.

Aspects of a planetary diagnostic-prognostic system (PDPS) are described in detail above to demonstrate, by way of example, aspects of the present invention. The present invention is not limited to wheel planetaries of LAV's. Indeed, other power transmission devices, such as differentials, can be readily analyzed using the systems and methods described herein with almost no modification. In general, embodiments may be employed to evaluate the health of any component of an electromechanical device, for example. In particular, to provide a context-independent approach, embodiments may be employed whenever several identical or near-identical systems are subjected to the similar or substantially similar operational contexts. Additionally, the approaches described herein may be more broadly applied to analyze a fleet where systems in the fleet are essentially subjected to the same conditions.

Aspects of the present invention, for example, may be employed as a part of a system, known as an Asset Health Management (AHM) system. The AHM system can be applied to military and non-military platforms, such as ships, aircraft, and ground vehicles, to enhance command and control effectiveness, improve maintenance and supply logistics, and reduce operations and support costs. Such a system represents a shift from a reactive maintenance philosophy to one of proactive maintenance. With the aspects of the present invention, AHM monitors the current health of the platform, reports operational information to operators and alerts them to abnormal conditions, and provides diagnostic information to platform maintainers. Additionally, AHM includes prognostic (predictive) capabilities to predict when platform components or sub-systems will fail or require maintenance and to calculate the remaining useful life of components. Moreover, AHM gathers data on platform components so that component or sub-system trends and usage patterns can be viewed and analyzed. As described previously, this data can be compared against previous platform data or against a fleet average or baseline. Mathematical or statistical methods can also be applied to the data to, for example, recognize component degradation over time. AHM allows platform maintainers to view on-board data or to transfer it to permanent off-board storage, where it can be accessed even when the platform is unavailable. AHM is also capable of transmitting logistics data to a remote location for use by maintenance and supply systems and to aid in fleet tracking. Logistics data typically includes platform location (e.g., latitude, longitude, heading, speed), state of health (e.g., abnormal condition alerts, diagnostic information), and key operating data (e.g., fuel level, ammunition level).

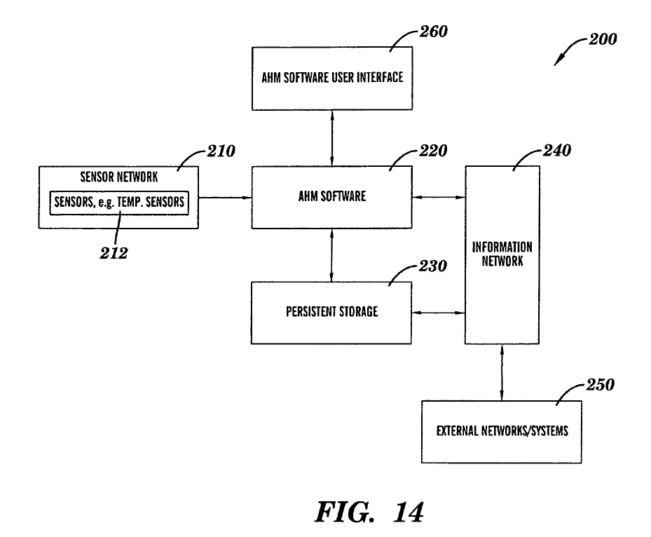

As shown in FIG. 14, embodiments of an AHM system 200 may have several components: a sensor network 210, AHM software 220 executed by one or more computing or processing systems, persistent storage 230, and an information network 240. The sensor network 210, which may include the planetary temperature sensors described previously, gathers data from sensors 212 and transmits this data to the AHM software 220. In general, the AHM software 220 provides a framework for building health monitoring systems. The software 220 reads data from a data carrying network 240, runs multiple levels of data processing algorithms, such as the component algorithm processing steps 130 described previously, in order to identify any system anomalies, and makes diagnostic and prognostic assessments. Any anomalies or problems detected by the software 220 may be sent to an appropriate user interface 260 so that operators or maintainers may take corrective actions. Data is stored by the system in persistent storage 230, which is a system, such as a database, that stores any data. Meanwhile, the information network 240 allows access to the data in persistent storage 230 by external systems 250. Data may be transferred from the AHM 200 to an external network or system 250 for higher level analysis and/or more permanent storage.

Accordingly, embodiments of the present invention provide an improved system and method that enables constant monitoring and proactive maintenance of components in an asset. Advantageously, the embodiments limit unplanned downtime and improve logistical planning by providing warnings as soon as problems with a component can be detected or predicted. With these warnings, corrective actions can be taken to prevent complete failure of the component and/or to prolong the service life of the electromechanical system. In some cases, because a warning can be provided well before failure, repairs and other corrective actions can be planned and logistical adjustments can be made in advance to minimize the impact of downtime. In other cases, the component has a finite operational life, but early warning enables arrangements to be made to retire and replace the asset.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A method for determining the health of a component of an asset, comprising:
receiving a collection of metrics from a plurality of components of an asset, the collection of metrics including a set of metrics corresponding to each component, the set of metrics measuring at least one operating characteristic of the corresponding component;
determining a relationship between each set of metrics corresponding to each component and the collection of metrics corresponding to the plurality of components; and
determining if the relationships indicate a health problem with at least one of the components.

2. The method according to claim 1, wherein the step of determining a relationship comprises determining a value representing the relationship, and the step of determining if the relationships indicate a health problem comprises applying a threshold to the value representing the relationship.

3. The method according to claim 1, wherein the step of determining relationships between each set of metrics and the collection of metrics comprises identifying an outlier corresponding to one of the components.

4. The method according to claim 3, further comprising determining an outlier characteristic value for the outlier.

5. The method according to claim 4, wherein the step of determining an outlier characteristic value comprises:
determining a first mean value corresponding to the plurality of components;
determining a first set of differences between the first mean value and measurements in each set of metrics corresponding to each component;
identifying, from the first set of differences, a first maximum difference, the first maximum difference corresponding to a candidate outlier component;
determining a second mean value corresponding to the plurality of components, excluding the candidate outlier component;
determining a second set of differences between the second mean value and the measurements in each set of metrics corresponding to each component;
identifying, from the second set of differences, a second maximum difference, the second maximum difference corresponding to the candidate outlier component;
determining a standard deviation according to the second set of differences excluding the second maximum difference, and
determining the outlier characteristic value as the ratio of the second maximum difference and the standard deviation.

6. The method according to claim 4, wherein the step of determining if the relationships indicate a health problem comprises comparing the outlier characteristic value to a threshold.

7. The method according to claim 1, wherein the step of receiving a collection of metrics comprises receiving the collection of metrics from sensors mounted to the plurality of components.

8. The method according to claim 7, further comprising detecting any faults in the sensors.

9. The method according to claim 8, wherein the step of detecting any faults in the sensors comprises:
determining a correlation coefficient between each pair of components; and
detecting a fault when the correlation coefficient is below a threshold.

10. The method according to claim 1, further comprising determining at least one of a short-term and a steady-state prediction for the at least one operating characteristic for each of the components.

11. The method according to claim 10, wherein the step of determining at least one of a short-term and a steady-state prediction comprises processing, in a neural network, measurements in each set of metrics.

12. The method according to claim 1, further comprising applying zero-order interpolation to the set of metrics corresponding to each component if the set of metrics includes measurements taken at a non-uniform sampling rate.

13. The method according to claim 1, further comprising categorizing a health of each component and communicating the health of each component to a user.

14. The method according to claim 1, wherein the components are planetaries and the collection of metrics includes temperature measurements for the planetaries.

15. The method according to claim 14, further comprising receiving speed data corresponding to a vehicle including the planetaries.

16. The method according to claim 14, wherein the temperature measurements are received from sensors positioned on a housing of each planetary.

17. The method according to claim 16, further comprising adjusting the temperature measurements received from the sensors on the housing to indicate temperatures of the planetary within each housing.

18. The method according to claim 17, wherein the step of adjusting the temperature measurements comprises adjusting the temperature measurements to indicate temperatures at planet gear pins of each planetrary.

19. The method according to claim 1, further comprising determining a remaining useful life for each component.

20. The method according to claim 19, wherein the components are planetaries, the collection of metrics includes temperature measurements for the planetaries, and the step of determining a remaining useful life for each planetary comprises determining a bushing thickness for each planetary.

21. The method according to claim 20, wherein the step of determining a bushing thickness for each planetary comprises determining wear coefficients for the bushing based on the temperature measurements.

22. The method according to claim 1, wherein the components are subject to substantially similar operating contexts.

23. A system for determining the health of a component of an asset, comprising:
a sensor network including sensors collecting metrics from a plurality of components of an asset, each component providing a set of metrics measuring at least one operating characteristic of the corresponding component; and
a processing system receiving the metrics from the sensor network, determining a relationship between each set of metrics corresponding to each component and the collection of metrics corresponding to the plurality of components, and determining if the relationships indicate a health problem with at least one of the components.

24. The system according to claim 23, wherein the processing system determines a value representing the relationship, and applies a threshold to the value representing the relationship.

25. The system according to claim 23, wherein the processing system identifies an outlier corresponding to one of the components.

26. The system according to claim 25, wherein the processing system determines an outlier characteristic value for the outlier.

27. The system according to claim 26, wherein the processing system determines an outlier characteristic value by:
determining a first mean value corresponding to the plurality of components;
determining a first set of differences between the first mean value and measurements in each set of metrics corresponding to each component;
identifying, from the first set of differences, a first maximum difference, the first maximum difference corresponding to a candidate outlier component;
determining a second mean value corresponding to the plurality of components, excluding the candidate outlier component;
determining a second set of differences between the second mean value and the measurements in each set of metrics corresponding to each component;
identifying, from the second set of differences, a second maximum difference, the second maximum difference corresponding to the candidate outlier component;
determining a standard deviation according to the second set of differences excluding the second maximum difference, and
determining the outlier characteristic value as the ratio of the second maximum difference and the standard deviation.

28. The system according to claim 26, wherein the processing system compares the outlier characteristic value to a threshold.

29. The system according to claim 23, wherein the processing system detects any faults in the sensors of the sensor network.

30. The system according to claim 29, wherein the processing system determines a correlation coefficient between each pair of components and detects a fault when the correlation coefficient is below a threshold.

31. The system according to claim 23, wherein the processing system determines at least one of a short-term and a steady-state prediction for the at least one operating characteristic for each of the components.

32. The system according to claim 31, wherein the processing system processes measurements in each set of metrics in a neural network.

33. The system according to claim 23, measurements in each set of metrics applies zero-order interpolation to the set of metrics corresponding to each component if the set of metrics includes measurements taken at a non-uniform sampling rate.

34. The system according to claim 23, further comprising a user interface coupled to the processing system and providing information on a health of each component, wherein the processing system categorizes the health of each component.

35. The system according to claim 23, wherein the components are planetaries and the sensor network collects temperature measurements for the planetaries.

36. The system according to claim 35, wherein the processing system further receives speed data corresponding to a vehicle including the planetaries.

37. The system according to claim 35, wherein each sensor is positioned on a housing of one of the planetaries.

38. The system according to claim 37, wherein the processing system adjusts the temperature measurements received from the sensors on the housing to indicate temperatures of the planetary within each housing.

39. The system according to claim 38, wherein the processing system adjusts the temperature measurements to indicate temperatures at planet gear pins of each planetrary.

40. The system according to claim 23, wherein the processing system determines a remaining useful life for each component.

41. The system according to claim 40, wherein the components are planetaries, the collection of metrics includes temperature measurements for the planetaries, and the processing system determines a bushing thickness for each planetary.

42. The system according to claim 41, wherein the processing system determines a bushing thickness for each planetary by determining wear coefficients for the bushing based on the temperature measurements.

43. The system according to claim 23, wherein the components are subject to substantially similar operating contexts.
